(19) United States
(12) Patent Application Publication
(10) Pub. No.: US 2023/0414326 A1
(43) Pub. Date: Dec. 28, 2023

(54) DEVICES FOR TREATING TEETH AND ASSOCIATED SYSTEMS AND METHODS

(71) Applicant: Brius Technologies, Inc., Carrollton, TX (US)

(72) Inventors: Seyed Mehdi Roein Peikar, Carrollton, TX (US); James Sylvester Wratten, JR., Waterville, NY (US)

(21) Appl. No.: 18/251,762

(22) PCT Filed: Nov. 3, 2021
(86) PCT No.: PCT/US2021/072214

§ 371 Date: May 4, 2023

Related U.S. Application Data
(60) Provisional application No. 63/110,338, filed on Nov. 5, 2020.

(51) Int. Cl. A61C 7/14

(52) U.S. Cl. CPC A61C 7/146

(57) ABSTRACT

An orthodontic device and associated systems and methods are disclosed herein. In some embodiments, the orthodontic device comprises an installation unit configured to temporarily be secured to a patient's teeth and hold or retain an orthodontic appliance, a bracket, a platform, and/or another orthodontic device in a desired position relative to the teeth for installation.

### CROSS-REFERENCE TO RELATED APPLICATION(S)

The present application claims the benefit of priority to U.S. Provisional Patent Application No. 63/110,338, titled DEVICES FOR TREATING TEETH AND ASSOCIATE SYSTEMS AND METHODS, filed Nov. 5, 2020.

This application is related to the following applications, each of which is hereby incorporated by reference in its entirety: U.S. patent application Ser. No. 16/865,323, titled DENTAL APPLIANCES, SYSTEMS AND METHODS, filed May 2, 2020; International Patent Application No. PCT/US20/31211, titled DENTAL APPLIANCES, SYSTEMS AND METHODS, filed May 2, 2020; U.S. patent application Ser. No. 15/929,443, titled DENTAL APPLIANCES AND ASSOCIATED SYSTEMS AND METHODS OF USE, filed May 2, 2020; U.S. patent application Ser. No. 15/929,444, titled DENTAL APPLIANCES AND ASSOCIATED SYSTEMS AND METHODS OF USE, filed May 2, 2020, U.S. Patent Application No. PCT/US20/70017, titled DENTAL APPLIANCES AND ASSOCIATED SYSTEMS AND METHODS OF USE, filed May 2, 2020; U.S. patent application Ser. No. 15/929,442, titled DENTAL APPLIANCES AND ASSOCIATED METHODS OF MANUFACTURING, filed May 2, 2020, International Application No. PCT/US20/70016, titled DENTAL APPLIANCES AND ASSOCIATED METHODS OF MANUFACTURING, filed May 2, 2020, U.S. Provisional Patent Application No. 62/956,290, filed Jan. 1, 2020, U.S. Provisional Patent Application No. 62/842,391, filed May 2, 2019, and U.S. Provisional Patent Application No. 62/704,545, titled DENTAL APPLIANCES AND ASSOCIATED SYSTEMS AND METHODS OF USE, filed May 15, 2020.

### TECHNICAL FIELD

The present technology relates to dental appliances for treating teeth and associated systems and methods.

### BACKGROUND

A common objective in orthodontics is to move a patient's teeth to positions where the teeth function optimally and aesthetically. To move the teeth, the orthodontist may begin by obtaining multiple scans and/or impressions of the patient's teeth to determine a series of corrective paths between the initial positions of the teeth and the desired ending positions. The orthodontist then fits the patient to one of two main appliance types: braces or aligners.

Traditional braces consist of brackets and an archwire placed across a front side of the teeth, with elastic ties or ligature wires to secure the archwire to the brackets. In some cases self-ligating brackets may be used in lieu of ties or wires. The shape and stiffness of the archwire as well as the archwire-bracket interaction governs the forces applied to the teeth and thus the direction and degree of tooth movement. To exert a desired force on the teeth, the orthodontist often manually bends the archwire. The orthodontist monitors the patient's progress through regular appointments, during which the orthodontist visually assesses the progress of the treatment and makes manual adjustments to the archwire (such as new bends) and/or replaces or repositions brackets. The adjustment process is both time consuming and tedious for the patient and more often than not results in patient discomfort for several days following the appointment. Moreover, braces are not aesthetically pleasing and make brushing, flossing, and other dental hygiene procedures difficult.

Aligners comprise clear, removable, polymeric shells having cavities shaped to receive and reposition teeth to produce a final tooth arrangement. Aligners offer patients significantly improved aesthetics over braces. Aligners do not require the orthodontists to bend wires or reposition brackets and are generally more comfortable than braces. However, unlike braces, aligners cannot effectively treat all malocclusions. Certain tooth repositioning steps, such as extrusion, translation, and certain rotations, can be difficult or impossible to achieve with aligners. Moreover, because the aligners are removable, success of treatment is highly dependent on patient compliance, which can be unpredictable and inconsistent.

Lingual braces are an alternative to aligners and traditional (buccal) braces and have been gaining popularity in recent years. Two examples of existing lingual braces are the Incognito™ Appliance System (3M United States) and INBRACE® (Swift Health Systems, Irvine, California, USA), each of which consists of brackets and an archwire placed on the lingual, or tongue side, of the teeth. In contrast to traditional braces, lingual braces are virtually invisible, and, unlike aligners, lingual braces are fixed to the patient's teeth and force compliance. These existing lingual technologies, however, also come with several disadvantages. Most notably, conventional lingual appliances still rely on a bracket-archwire system to move the teeth, thus requiring multiple office visits and painful adjustments. For example, lingual technologies have a relatively short inter-bracket distance, which generally makes compliance of the archwire stiffer. As a result, the overall lingual appliance is more sensitive to archwire adjustments and causes more pain for the patient. Moreover, the lingual surfaces of the appliance can irritate the tongue and impact speech, and make the appliance difficult to clean.

Therefore, a need exists for improved orthodontic appliances.

### SUMMARY

The subject technology is illustrated, for example, according to various aspects described below, including with reference to FIGS. 1A-7B. Various examples of aspects of the subject technology are described as numbered clauses (1, 2, 3, etc.) for convenience. These are provided as examples and do not limit the subject technology.

1. An installation unit for installing an orthodontic treatment device in a patient's mouth, the installation unit comprising:
a body portion having a shape that corresponds to a plurality of the patient's teeth; and
a plurality of connection portions configured to be releasably secured to an orthodontic appliance, wherein the orthodontic appliance is configured to be secured to two or more of the patient's teeth and apply a force to the two or more of the patient's teeth to reposition the two or more teeth,
wherein the installation unit is configured to temporarily retain the orthodontic appliance in a position relative to the installation unit such that, when the installation unit is placed on the patient's teeth, the orthodontic appliance is automatically aligned with the patient's teeth in a desired position for connecting to the teeth.

2. The installation unit of Clause 1, wherein the connection portions are disposed along a lingual-facing surface of the body portion.

3. The installation unit of Clause 1, wherein each connection portion extends away from the body portion.

4. The installation unit of Clause 21, wherein at least some of the connection portions are configured to be releasably secured to the orthodontic appliance via a snap fit arrangement.

5. The installation unit of Clause 21, wherein at least some of the connection portions are configured to be releasably secured to the orthodontic appliance via a friction fit arrangement.

6. The installation unit of Clause 21, wherein at least some of the connection portions are configured to be releasably secured to the orthodontic appliance via a separate securing element.

7. The installation unit of Clause 21, wherein the body portion has an arch or partial arch shape.

8. The installation unit of Clause 21, wherein the body portion has an arch shape corresponding to a dental impression of the patient's jaw.

9. The installation unit of Clause 21, wherein the orthodontic appliance comprises an anchor portion configured to be installed along the patient's teeth and a plurality of arms extending away from the anchor portion.

10. An installation unit for installing an orthodontic treatment device in a patient's mouth, the installation unit comprising:
a body portion having a shape that corresponds to a plurality of the patient's teeth; and
a plurality of connection portions carried by the body portion and configured to be releasably secured to the orthodontic treatment device, the orthodontic treatment device comprising (a) an orthodontic appliance configured to be secured to two or more of the patient's teeth and apply a force to the two or more teeth to reposition the two or more teeth, (b) at least one bracket coupled to the orthodontic appliance,
wherein the installation unit is configured to temporarily retain the orthodontic treatment device in a position relative to the installation unit such that, when the installation unit is placed on the patient's teeth, the orthodontic treatment device is automatically aligned with the patient's teeth in a desired position for connecting the orthodontic treatment device to one or more of the teeth via the at least one bracket.

11. The installation unit of Clause 30, wherein each of the connection portions comprises a recessed portion configured to receive a portion of the orthodontic treatment device.

12. The installation unit of Clause 30, wherein each of the connection portions comprises a recessed portion configured to receive a portion of the orthodontic appliance and/or the at least one bracket.

13. The installation unit of Clause 30, wherein the orthodontic appliance comprises an anchor portion configured to be installed along the patient's teeth and a plurality of arms extending away from the anchor portion.

14. The installation unit of Clause 30, wherein the connection portions are disposed along a lingual-facing surface of the body portion.

15. The installation unit of Clause 30, wherein at least some of the connection portions extend away from the body portion.

16. The installation unit of Clause 30, wherein at least some of the connection portions are configured to be releasably secured to the orthodontic treatment device via a friction fit arrangement.

17. The installation unit of Clause 30, wherein at least some of the connection portions are configured to be releasably secured to the orthodontic treatment device via a snap fit arrangement.

18. The installation unit of Clause 30, wherein at least some of the connection portions are configured to be releasably secured to the orthodontic treatment device via a separate securing element.

19. The installation unit of Clause 30, wherein each connection portion corresponds to an individual one of the patient's teeth.

The installation unit of Clause 30, wherein the body portion has an arch shape corresponding to a dental impression of the patient's jaw.

21. An installation unit for installing an orthodontic appliance or a platform on a patient, the installation unit comprising a body portion having a shape that corresponds to one or more (or a plurality of) teeth in one of the patient's jaws, wherein the body portion is configured to hold an appliance during installation of the appliance on the patient's teeth, and wherein the body portion includes a plurality of connection portions for temporarily connecting with the orthodontic appliance during installation, the plurality of connection portions being configured to release the appliance from the body portion, after the appliance is installed on the patient.

22. The installation unit of Clause 21, further comprising at least one wire or tie member for temporarily connecting the orthodontic appliance to the plurality of connection portions.

23. The installation unit of Clause 21, further comprising at least one slot or receptacle in or between the plurality of connection portions, for receiving and temporarily holding one or more sections of the orthodontic appliance.

24. The installation unit of Clause 21, wherein the body portion having a shape corresponding to a plurality of teeth in the patient's jaw.

25. The installation unit of Clause 21, wherein the body portion has an arch shape corresponding to a dental impression of the patient's jaw.

26. The installation unit of Clause 21, wherein each connection portion comprises a hook, tab or finger extension on the body portion.

27. The installation unit of Clause 21, wherein the body portion has an arch shape and the installation unit further comprises a central frame portion extending within the arch shape of the body portion, the central frame portion is configured to hold the platform during installation of the platform on the patient.

28. The installation unit of Clause 27, wherein the central frame portion includes one or more (or a plurality of) connection portions for temporarily connecting with the platform during installation, the plurality of connection portions being configured to release the platform from the central frame portion, after the platform is installed on the patient.

29. A method of making an installation unit for installing an orthodontic appliance or a platform on a patient, the method comprising:
forming a body portion having a shape that corresponds to one or more (or a plurality of) teeth in one of the patient's jaws, wherein the body portion is configured to hold an appliance during installation of the appliance on the patient's teeth; and
providing a plurality of connection portions on the body for temporarily connecting with the orthodontic appliance during installation, the plurality of connection portions being configured to release the appliance from the body portion, after the appliance is installed on the patient.

30. The method of Clause 29, further comprising providing at least one wire or tie member for temporarily connecting the orthodontic appliance to the plurality of connection portions.

31. The method of Clause 29, further comprising providing at least one slot or receptacle in or between the plurality of connection portions, for receiving and temporarily holding one or more sections of the orthodontic appliance.

32. The method of Clause 29, wherein the body portion has an arch shape and the method further comprises forming a central frame portion that extends within the arch shape of the body portion to hold the platform during installation of the platform on the patient.

33. The method of Clause 32, wherein forming the central frame portion comprises configuring one or more (or a plurality of) connection portions for temporarily connecting with the platform during installation, and to release the platform from the central frame portion after the platform is installed on the patient.

34. A method of installing an appliance comprising:
providing an installation unit having a body configured in a shape that corresponds to one or more (or a plurality of) teeth in one of the patient's jaws;
connecting an appliance to the installation unit;
placing the installation unit, having the appliance connected thereto, onto the one or more (or plurality of) teeth in the patient's jaw;
securing the appliance to the one or more (or plurality of) teeth in the patient's jaw, while the appliance is connected to the installation unit and while the installation unit is on the one or more (or plurality of) teeth;
disconnecting the appliance from the installation unit, while the appliance is secured to the one or more (or plurality of) teeth in the patient's jaw; and
removing the installation unit from the one or more (or plurality of) teeth in the patient's jaw, while the appliance remains secured to the one or more (or plurality of) teeth.

35. The method of Clause 34, further comprising connecting one or more (or a plurality of) brackets to the appliance before securing the appliance to the one or more (or plurality of) teeth, wherein securing the appliance comprises connecting the one or more (or a plurality of) brackets to the one or more (or plurality of) teeth in the patient's jaw while the appliance is connected to the installation unit.

36. The method of Clause 35, wherein connecting the one or more (or a plurality of) brackets to the one or more (or plurality of) teeth in the patient's jaw comprises bonding the one or more (or a plurality of) brackets to the one or more (or plurality of) teeth in the patient's jaw.

37. The method of Clause 34, wherein connecting an appliance to the installation unit comprises providing one or more temporary connectors, and connecting the appliance to the installation unit with the one or more temporary connectors.

38. The method of Clause 37, wherein the one or more temporary connector elements comprise one or more wire ties.

39. The method of Clause 34, wherein connecting an appliance to the installation unit comprises extending one or more arms of the appliance through one or more slots or gaps in the installation unit, and wherein disconnecting the appliance from the installation unit comprises removing the one or more arms of the appliance from the slots or gaps in the installation unit.

40. The method of Clause 34, wherein providing an installation unit comprises forming or selecting the installation unit body having a shape that corresponds to the one or more (or plurality of) teeth in the patient's jaw, and wherein placing the installation unit onto the one or more (or plurality of) teeth comprises fitting the installation unit body over the one or more (or plurality of) teeth.

41. The method of Clause 34, wherein providing an installation unit comprises forming or selecting the installation unit body having an arch shape and a central frame portion that extends within the arch shape of the body to hold a platform during installation of the platform on the patient, and wherein the method further comprises: connecting the platform to the central frame portion before placing the installation unit onto the one or more (or plurality of) teeth in the patient's jaw; installing the platform on the patient after placing the installation unit onto the one or more (or plurality of) teeth in the patient's jaw; and disconnecting the platform from the central frame after installing the platform.

42. An installation unit for installing an orthodontic treatment device in a patient's mouth, the installation unit comprising:
a device configured to be temporarily secured to one or more of the patient's teeth, the device comprising a first coupling region and a second coupling region, wherein:
   the first coupling region comprises one or more indentations in a surface of the device that are shaped to detachably receive (a) all or a portion of an orthodontic appliance, (b) all or a portion of a bracket, or (c) both, wherein the orthodontic appliance is configured to be secured to two or more of the patient's teeth and apply a force to the two or more of the patient's teeth to reposition the two or more teeth,
   the second coupling region comprises one or more recesses in a surface of the device that are shaped to detachably receive at least a portion of the one or more of the patient's teeth,
wherein the installation unit is configured to temporarily retain the orthodontic appliance in a position relative to the installation unit such that, when the installation unit is placed on the patient's teeth, the orthodontic appliance is automatically aligned with the patient's teeth in a desired position for connecting to the teeth.

43. The installation unit of Clause 42, wherein device comprises a flexible cover configured to fit over the one or more teeth.

44. The installation unit of Clause 42 or Clause 43, wherein the device comprises an outer surface and an inner surface configured to be in apposition with at least a portion of the one or more teeth when the installation unit is secured to the one or more teeth, and wherein the grooves and the recesses are in the inner surface.

45. The installation unit of any one of Clauses 42 to 44, wherein the grooves are configured to detachably receive the orthodontic appliance via a snap fit arrangement.

46. The installation unit of any one of Clauses 42 to 45, wherein the recesses are configured to detachably receive the one or more teeth via a snap fit arrangement.

47. The installation unit of any one of Clauses 42 to 46, wherein the device has an arch or partial arch shape.

48. The installation unit of any one of Clauses 42 to 47, wherein the device has an arch shape corresponding to a dental impression of the patient's jaw.

49. The installation unit of any one of Clauses 42 to 48, wherein the orthodontic appliance comprises an anchor portion configured to be installed along the patient's teeth and a plurality of arms extending away from the anchor portion.

50. The installation unit of any one of Clauses 42 to 49, wherein the orthodontic appliance comprises a plurality of attachment portions configured to be secured to a corresponding bracket and a plurality of connectors extending between attachment portions, wherein at least one of the connectors is a spring.

51. The installation unit of any one of Clauses 42 to 50, wherein the device further comprises one or more third coupling regions configured to detachably receive all or a portion of a platform.

52. An installation unit for installing an orthodontic treatment device in a patient's mouth, the installation unit comprising:
a shell having a shape that corresponds to one or more teeth in one of the patient's jaws, wherein the body portion is configured to hold an orthodontic device during installation of the appliance on the patient's teeth, and wherein the shell has an outer surface, an inner surface, and a recess defined by the inner surface, wherein the inner surface includes:
   a groove configured to receive at least a portion of the orthodontic device, wherein the orthodontic device comprises one or more of an orthodontic appliance, a bracket, and a platform,
   an indentation shaped to detachably receive at least a portion of one or more of the patient's teeth,
wherein the installation unit is configured to temporarily retain the orthodontic device in a position relative to the installation unit such that, when the installation unit is placed on the patient's teeth, the orthodontic device is automatically aligned with the patient's teeth in a desired position for connecting to the teeth.

53. The installation unit of Clause 52, wherein the orthodontic appliance is configured to be secured to two or more of the patient's teeth and apply a force to the two or more of the patient's teeth to reposition the two or more teeth.

54. The installation unit of any one of Clause 52 or Clause 53, wherein the first groove is configured to detachably couple directly to the orthodontic appliance.

55. The installation unit of any one of Clauses 52 to 54, wherein the first groove is configured to detachably couple to at least a portion of one or more brackets while the one or more brackets are coupled to the orthodontic appliance.

56. The installation unit of any one of Clauses 52 to 55, wherein the first groove is configured to detachably couple to at least a portion of one or more brackets and all or a portion of the orthodontic appliance while the one or more brackets are coupled to the orthodontic appliance.

57. The installation unit of any one of Clauses 52 to 56, wherein the first groove is configured to detachably couple to at least a portion of one or more brackets and all or a portion of the orthodontic appliance while the one or more brackets are coupled to the orthodontic appliance, and while the orthodontic appliance is coupled to the platform.

58. The installation unit of any one of Clauses 52 to 57, wherein the shell has an arch or partial arch shape.

59. The installation unit of any one of Clauses 52 to 58, wherein the device has an arch shape corresponding to a dental impression of the patient's jaw.

60. The installation unit of any one of Clauses 52 to 59, wherein the inner surface is configured to be in apposition with at least a portion of the one or more teeth when the installation unit is secured to the one or more teeth.

61. The installation unit of any one of Clauses 52 to 60, wherein the groove is configured to detachably receive the orthodontic device via a snap fit arrangement.

62. The installation unit of any one of Clauses 52 to 61, wherein the indentation is configured to detachably receive the one or more teeth via a snap fit arrangement.

63. The installation unit of any one of Clauses 52 to 62, wherein the orthodontic device comprises at least the orthodontic appliance, and the orthodontic appliance comprises an anchor portion configured to be installed along the patient's teeth and a plurality of arms extending away from the anchor portion.

64. The installation unit of any one of Clauses 52 to 63, wherein the orthodontic device comprises at least the orthodontic appliance, and the orthodontic appliance comprises a plurality of attachment portions configured to be secured to a corresponding bracket and a plurality of connectors extending between attachment portions, wherein at least one of the connectors is a spring.

65. An orthodontic treatment system comprising:
an orthodontic appliance;
an installation unit configured to be temporarily secured to one or more of a patient's teeth, wherein the installation unit includes a groove shaped to receive all or a portion of the orthodontic appliance therein such that, when the orthodontic appliance is secured to the one or more teeth in the patient's mouth, the installation unit holds the orthodontic appliance in a desired position relative to the teeth for installation of the orthodontic appliance.

66. The system of Clause 65, further comprising a plurality of brackets coupled to the orthodontic appliance.

67. The system of Clause 65 or Clause 66, further comprising a platform coupled to the orthodontic appliance.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B schematically illustrate directional references relative to a patient's dentition.

FIGS. 2A and 2B are top and bottom views, respectively, of an installation unit configured in accordance with several embodiments of the present technology. In FIGS. 2A and 2B, the installation unit is shown coupled to an orthodontic appliance.

FIG. 3A is a top view of an installation unit configured in accordance with several embodiments of the present technology, shown coupled to an orthodontic appliance and a platform. In FIG. 3A, the installation unit assembly is shown positioned on a model of a patient's lower jaw.

FIGS. 3B, 3C, 3D, and 3E are top, bottom, top right, and top left views, respectively, of the installation unit assembly shown in FIG. 3A.

FIG. 4A shows an installation unit configured in accordance with several embodiments of the present technology.

FIG. 4B is an enlarged view of a portion of the installation unit of FIG. 4A.

FIGS. 5A and 5B are different views of an orthodontic appliance for use with the installation units of the present technology, shown coupled to a plurality of brackets.

FIGS. 6A and 6B are different views of the installation unit of FIGS. 4A and 4B shown coupled to the orthodontic appliance assembly shown in FIGS. 5A and 5B.

FIG. 7A depicts a portion of an orthodontic appliance for use with the installation units of the present technology.

FIG. 7B shows an installation unit configured in accordance with several embodiments of the present technology. In FIG. 7B, the installation unit is shown coupled to an orthodontic appliance.

### DETAILED DESCRIPTION

### Definitions

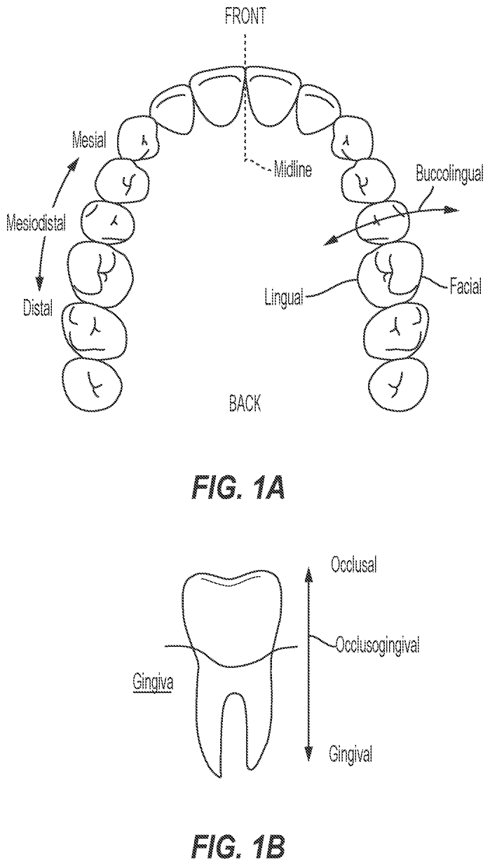

FIGS. 1A and 1B schematically depict several directional terms related to a patient's dentition. Terms used herein to provide anatomical direction or orientation are intended to encompass different orientations of an orthodontic appliance and/or an orthodontic device as installed in the patient's mouth, regardless of whether the structure being described is shown installed in a mouth in the drawings. As illustrated in FIGS. 1A and 1B: “mesial” means in a direction toward the midline of the patient's face along the patient's curved dental arch; “distal” means in a direction away from the midline of the patient's face along the patient's curved dental arch; “occlusal” means in a direction toward the chewing surfaces of the patient's teeth; “gingival” means in a direction toward the patient's gums or gingiva; “facial” means in a direction toward the patient's lips or cheeks (used interchangeably herein with “buccal” and “labial”); “lingual” means in a direction toward the patient's tongue; and “palatal” means in a direction toward the patient's palate. As used herein, the terms “proximal” and “distal” refer to a position that is closer and farther, respectively, from a given reference point. In many cases, the reference point is a certain connector, such as an anchor, and “proximal” and “distal” refer to a position that is closer and farther, respectively, from the reference connector along a line passing through the centroid of the cross-section of the portion of the appliance branching from the reference connector.

As used herein, the terms “generally,” “substantially,” “about,” and similar terms are used as terms of approximation and not as terms of degree, and are intended to account for the inherent variations in measured or calculated values that would be recognized by those of ordinary skill in the art.

As used herein, the term “operator” refers to a clinician, practitioner, technician or any person or machine that designs and/or manufactures an orthodontic appliance or portion thereof, and/or facilitates the design and/or manufacture of the appliance or portion thereof, and/or any person or machine associated with installing the appliance in the patient's mouth and/or any treatment of the patient associated with the appliance.

As used herein, the term “force” refers to the magnitude and/or direction of a force, a torque, or a combination thereof.

As used herein, the term “orthodontic appliance” or “appliance” refers to an orthodontic device configured to be secured to two or more of the patient's teeth and apply a force to the two or more of the patient's teeth to reposition the two or more teeth from an original tooth arrangement (OTA) to a desired final tooth arrangement (FTA). In various embodiments, the orthodontic appliance can take any number of forms. As described in further detail herein, in some embodiments, the orthodontic appliance can comprise a deformable member that includes one or more attachment portions, each configured to be secured to a tooth surface directly or indirectly via a securing member, and one or more connectors, each extending directly between attachment portions, between an attachment portion and one or more other connectors, or between two or more other connectors. Additionally or alternatively, the orthodontic appliance can comprise traditional braces, aligners, lingual braces, or other suitable orthodontic appliances.

The orthodontic appliances (and components of the appliances) as described herein may be made of any suitable material including, but not limited to Nitinol (NiTi), stainless steel, beta-titanium, cobalt chrome or other metal alloy, polymers or ceramics, and may be made as a single, unitarily-formed structure or, alternatively, in multiple separately-formed components connected together in a single structure. In certain examples, appliances (or certain components of appliances) are formed in a single, unitary and integral structure, and are not made by connecting separately formed elements together.

Certain examples described herein include or employ a fixed orthodontic appliance that cannot be removed by the patient, once the appliance is installed on the patient's teeth. Other examples described herein include or employ a removable appliance that can be selectively removed and installed on the patient's teeth, by the patient. Examples that include or employ a fixed appliance may require or involve less patient cooperation and training, as compared to examples that include or employ removable orthodontic techniques.

Particular example embodiments described herein allow for computerized design and manufacturing, for example, to design or to custom configure various aspects of one or more appliances, appliance members or additional elements that may be employed with an appliance (including installation units, platforms, aligners and retainers). Computerized design and manufacturing techniques may be employed to design and/or manufacture appliances or appliance members (or portions or components thereof), including one or more (or each) spring, arm, rigid bar, bracket connector, or other feature of the appliance or appliance member, in according to any of the examples described herein. Such computerized design and manufacture may be based on computer input associated with which tooth or teeth is/are to be moved and the desired amount and direction of movement. In particular examples, a computerization of the shape and features of the appliance and/or manufacturing techniques described herein, can provide significant advantages. In particular examples, such computerization can simplify the treatment process for the clinician and can increase treatment precision as compared to traditional techniques. In certain examples, an appliance, appliance member, or components thereof, according to any of the examples described herein may be made, after rearranging a three dimensional (3D) digital OTA to a 3D digital FTA, and designing (via computer aided design or other suitable design techniques) an appliance shape that is configured to impart forces on the patient's teeth to move the teeth from the OTA to the FTA (or to an ITA, or from an ITA to an FTA or another ITA).

### II. Installation Units

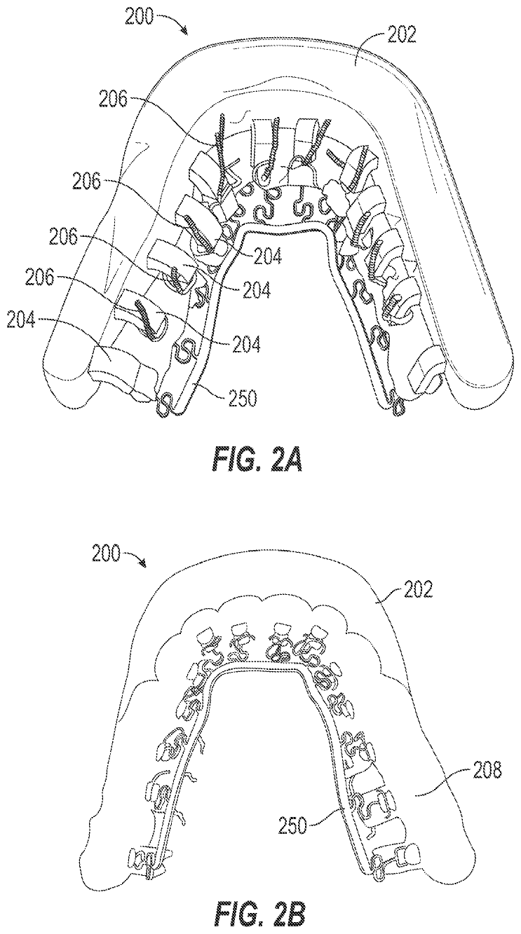

Various embodiments of the present technology comprise orthodontic devices, such as installation units, configured to facilitate installation of an orthodontic appliance, one or more brackets, and/or a platform in a patient's mouth. In some embodiments, the present technology comprises an installation unit configured to hold an orthodontic appliance, brackets, and/or a platform in a desired position and/or orientation relative to the patient's teeth during installation of the orthodontic appliance, brackets, and/or platform. Unlike conventional indirect bonding trays (IDBs) that guide installation of brackets only, the installation units of the present technology are configured to support simultaneous installation of two or more of an orthodontic appliance, brackets, and a platform. Various examples of installation units of the present technology are described with regard to FIGS. 2A-7B.

FIGS. 2A and 2B are top and bottom views of an installation unit 200 of the present technology, shown coupled to an orthodontic appliance 250. The installation unit 200 is configured to temporarily hold the orthodontic appliance 250 in a desired position relative to the patient's dentition during installation of the orthodontic appliance 250. As shown, the installation unit 200 may comprise a body portion 202 and a plurality of connection portions 204 carried by the body portion 202 and configured to detachably couple to the orthodontic appliance 250. In some embodiments the connection portions 204 comprise grooves or recesses in the body portion 202. Additionally or alternatively, the connection portions 204 may comprise arms extending away from the body portion 202. The installation units described herein may be configured of any suitable material including, but not limited to a plastic, a rubber, a metal, a composite material, or the like, or combinations thereof. The installation units may be formed by any suitable manufacturing process including, but not limited to molding, 3D printing, machining, and others.

The body portion 202 is configured to be temporarily secured to one or more of the patient's teeth during installation of the orthodontic appliance 250. In some embodiments, the body portion 202 is configured to fit onto one or more (or a plurality of) teeth in a patient's jaw (an upper jaw or a lower jaw). In certain examples, the body portion 202 may have a shape that corresponds to the entire set of teeth in one of the patient's jaws. For example, the body portion 202 may have an arch shape (or partial arch shape) of an intraoral scan or a dental impression formed of the patient's jaw. Accordingly, the body portion 202 may include a recess 208 (visible in FIG. 2B) for receiving all or a portion of one or more (or all) of the teeth in a patient's jaw, when installed, so that the installation unit 200 may be secured relative to a patient's jaw. In particular examples, the body portion 202 is formed from an actual impression or computer rendition of the patient's teeth, so that the body portion 202 fits the patient's teeth in a customized manner. In other examples, the body portion 202 may be configured to fit a plurality of patients (and not customized for a particular patient). For example, various installation unit sizes can be made, to fit a large portion of the public, without requiring a customized body portion 202 for each patient.

The connection portions 204 may be integral with the body portion 202 or may be separate components that are coupled to the body portion. The connection portions 204 may comprise one or more hooks, tabs, fingers or the like, located or extending along the inward-facing surface of the arch shape (for installing an appliance on the inner or lingual surface of a patient's teeth). In other examples, the body portion 202 of the installation unit 200 may include a similar plurality of connection portions (such as, but not limited to hooks, tabs, fingers or the like) located or extending along the outward-facing surface of the arch shape (for installing an appliance on the outer or buccal surface of a patient's teeth).

In some embodiments, the connection portions 204 are configured for retaining temporary wire or tie members 206 that temporarily secure the appliance 250 to the body portion 202 of the installation unit 200. In other examples, the connection portions 204 may be configured with slots or receptacles to receive and temporarily retain brackets and/or arms or other portions of the appliance in a friction fit or snap fitting arrangement. For example, the installation unit 200 may be configured with a plurality of connection portions 204 corresponding in number to the number of arms extending from the rigid bar of the appliance 250 (or corresponding in number to the number of bracket connectors on the appliance 250). As shown in FIG. 2A, the appliance 250 may be coupled to the installation unit 200, by a plurality of wires or ties 206, where each wire or tie 206 couples an arm or a bracket connector of the appliance 250 to a respective one of the connection portions 204 of the installation unit 200 (for example, by twisting or tying the wire or tie around or through the arm or bracket connector and around or through the connection portion). In this manner, the appliance 250 may be held by the installation unit 200, during an installation procedure (for installing the appliance onto a patient's teeth).

More specifically, an installation process may include forming or selecting an appliance 250 and forming or selecting an installation unit 200 to correspond to the patient's teeth in that jaw (for example, to match an impression of a patient's teeth) and to correspond to an appliance. After forming the appliance 250, each of the bracket connectors on the appliance may be connected to a corresponding bracket. In addition, the appliance (with the brackets connected) may be secured to the connection portions 204 of the installation unit 200, by wire ties (or other suitable tie structure, or other temporary connection mechanism). The appliance may be secured to the connection portions 204 directly, or indirectly via securement of the brackets to the connection portions 204. Then, the installation unit 200 (with the appliance 250 and brackets attached) can be fitted (placed) on a patient's teeth. In certain examples, the arms of the appliance 250 extend through slots or gaps between adjacent connection portions 204 (such as, but not limited to between hooks, tabs, fingers or the like), located or extending along the arch shape, such that the brackets that are already connected with bracket connectors on the appliance arms are arranged adjacent respective teeth, when the installation unit 200 is fitted (placed) on the patient's teeth. Then, the brackets may be bonded to respective teeth, while the installation unit 200 (holding the appliance 250) is on the patient's teeth. Once the brackets are bonded to the patient's teeth, the appliance 250 may be freed from the installation unit 200 (for example, by untying or cutting the wire or ties), and the installation unit 200 may be removed, while leaving the appliance 250 connected to the brackets in place on the patient's teeth.

In particular examples, the appliance 250 is secured to the installation unit 200 at a position that locates the appliance 250 at its proper installation location on the patient's jaw, when the installation unit 200 is fitted onto the patient's teeth (and the teeth are received within the recess 202a). Therefore, once the installation unit 200 (with the appliance 250 attached) is placed on the patient's teeth, the appliance 250 is automatically aligned with the patient's teeth, in a position for connecting to the brackets on the patient's teeth. In several embodiments, including any of the installation unit embodiments discloses herein, the installation unit is configured to retain an orthodontic appliance while the orthodontic appliance is in an OTA. As such, when the installation unit is removed from the patient's mouth after the orthodontic device is secured to the patient's teeth, the orthodontic appliance immediately applies a repositioning force to the teeth.

In other examples, the installation unit 200 may be used to install the appliance, after the brackets have been bonded to the patient's teeth. In such examples, the appliance 250 is secured to the installation unit 200 (by wire, other tie structures, or other temporary connection mechanism as described herein). In addition, each bracket is bonded to a respective tooth. Then, the installation unit 200 (with the appliance secured thereto) is placed or fitted onto the patient's teeth. The bracket connector elements on the appliance are then secured to the brackets and the wire, ties or other temporary connection mechanisms are released or removed, to release the appliance from the installation unit 200, while the appliance 250 is secured to the patient's teeth. Then, the installation unit 200 may be removed (slipped off of the patient's teeth), while the appliance 250 remains connected to the patient's teeth.

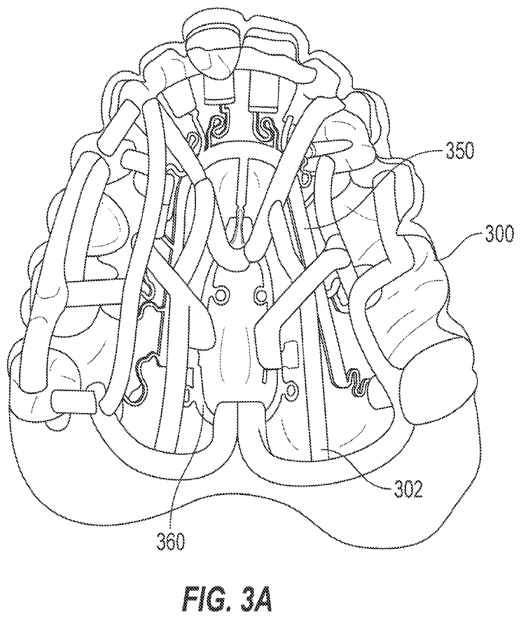

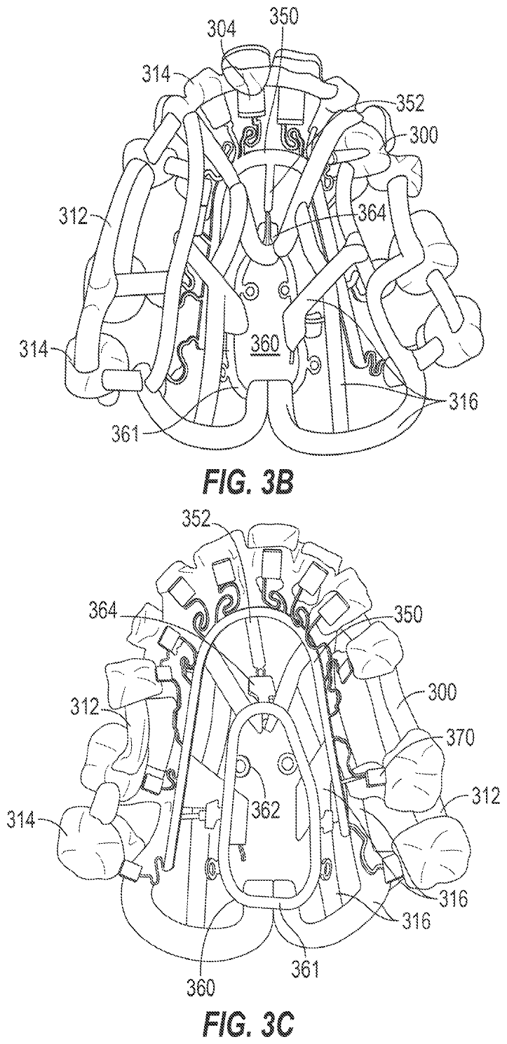

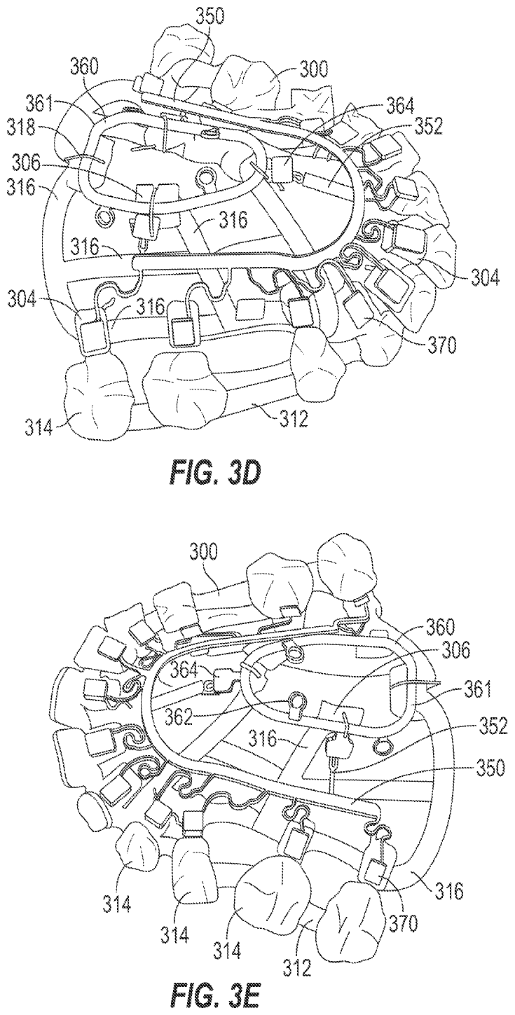

FIG. 3A is a top view of an installation unit 300 configured in accordance with several embodiments of the present technology, shown secured to an orthodontic device and positioned on a model of a patient's lower jaw. The installation unit and orthodontic device, as assembled, are referred to herein as an “installation unit assembly.” In FIG. 3A, the orthodontic device comprises an orthodontic assembly (i.e., orthodontic appliance 350 coupled to brackets) coupled to a platform 360. Additionally or alternatively, as discussed herein, the installation unit 300 may be configured to hold or facilitate installment of other orthodontic devices.

FIGS. 3B, 3C, 3D, and 3E are top, bottom, top right, and top left views, respectively, of the installation unit assembly shown in FIG. 3A. The platform 360 may be configured to engage or secure an orthodontic appliance (such as orthodontic appliance 350) to a maxilla or a mandible bone of a patient. As shown in FIGS. 3B-3E, for example, the appliance 350 includes platform connection arms 352 configured to be selectively coupled to a platform (such as platform 360). In some embodiments, the platform 360 comprises an annular body 361, one or more anchorage device connector elements 362, and one or more appliance connector elements 364. In other examples, the platform body 361 may have other suitable shapes and configurations, including but not limited to plate-shaped or cup-shaped configurations that are not annular.

In the example platform 360 shown in FIGS. 3A-3E, each of the anchorage device connector elements 362 extend from the annular body 361, toward the center of (or inward from) the annular shape. Also in the example in FIGS. 3A-3E, each of the appliance connector elements 364 extend from the annular body 361, in a direction away from the center of (or outward from) the annular shape. In other examples, some or all of the anchorage device connector elements may extend outward, or one or more of the appliance connector elements may extend inward, relative to the annular shape of the body.

Each of the anchorage device connector elements 362 is configured to hold a permanent anchorage device or a temporary anchorage device (TAD). In certain examples, the anchorage device connector elements 362 may correspond to the TAD holders described in U.S. patent application Ser. No. 15/370,704 (Publ. No. 2017/0156823) (for example, at reference numbers 812, 904 or 1012 in that application). The anchorage device connector elements 362 allow a clinician to secure the annular body 361 of the platform 360 to a patient's palate using one or more anchoring devices such as, but not limited to screws, TADs or other suitable anchorage device that extend into the patient's palate (soft and hard tissue). In certain examples, each anchorage device connector element 362 may have an opening (e.g., an opening in an annular extension) through which a screw, TAD or other anchor device may extend. In other examples, other suitable anchorage device connector element configurations may be employed for receiving or holding a screw, TAD or other anchor device.

Each of the appliance connector elements 364 of the platform 360 is configured to be selectively connected with a respective platform connection arm on an appliance (such as arms 352 of orthodontic appliance 350). Each appliance connector element 364 may have a configuration corresponding to any of the brackets (or female connector elements) described herein or in U.S. patent application Ser. No. 15/370,704 (Publ. No. 2017/0156823). Each platform connection arm 352 may have a configuration corresponding to any of the bracket connectors (or male connector elements) described herein or in U.S. patent application Ser. No. 15/370,704 (Publ. No. 2017/0156823). In some examples, each appliance connector element 364 and each platform connection arm 352 may have any other suitable configuration for selectively connecting and disconnecting from each other. In certain examples, each appliance connector element 364 has a configuration that includes a receptacle for receiving and holding a portion of respective platform connection arm of an appliance.

As shown in FIGS. 3B-3E, the installation unit 300 may comprise one or more retention portions 314, one or more first connection portions 304 carried by the retention portion(s) 314, a frame 316, and one or more second connection portions 306 carried by the frame 316. The retention portions 314, first connection portions 304, frame 316, and second connection portions 306 may comprise an integral structure, or one, some, or all of the foregoing components can be formed separately and attached to one or more of the other components. The frame 316 may comprise a plurality of interconnected struts. The struts may be coupled to or integral with the retention portion(s) 314. In some embodiments, at least some of the struts extend lingually away from the retention portion(s) 314 and/or another portion of the frame 316. In some embodiments, at least some of the struts extend mesiodistally and/or forward/backward along the mouth. The frame 316 may be formed of a rigid material to help hold the platform in place during installation.

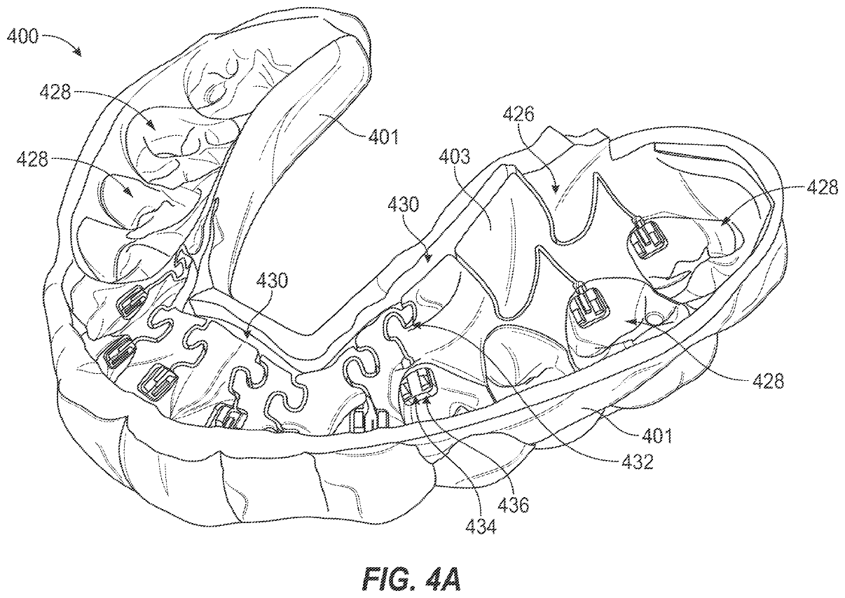

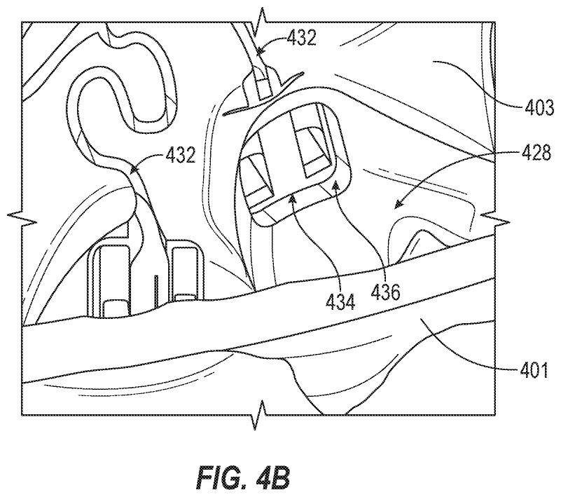

The retention portions 314 are configured to secure the installation unit 300 to one or more of the patient's teeth during installation of the appliance 350 and/or platform 360. For example, the retention portion 314 can comprise a single continuous shell or a plurality of discrete shells (as shown in FIGS. 3A-3E), each defining a recess having a shape substantially conforming to all or a portion of a shape of the one or more teeth to which the retention portion is intended to be coupled. In some embodiments, the recess has a shape configured to substantially conform to at least an occlusal surface of the one or more teeth. The individual shells may be coupled to one another by a plurality of bridges 312, each extending between adjacent shells. In some instances it may be preferable to have individual shells and/or retention portions for each of the teeth being engaged by the installation unit and that are connected by narrow bridges. Such a configuration requires less material and covers less of the patient's mouth than a larger shell that covers more of the patient's teeth and gingiva (for example as shown in FIGS. 2A and 4A), thus improving visibility of the patient's mouth and dentition for the clinician. In some embodiments, the retention portion 314 may have other suitable configurations, such as one or more bands configured to fit over the one or more reference teeth. In some embodiments, the retention portion comprises an arch or partial arch shape corresponding to a dental impression of the patient's jaw. In particular examples, the retention portion 314 (whether a plurality of discrete portions or a continuous member) is formed from an actual impression or computer rendition of the patient's teeth, so that the retention portion 314 fits the patient's teeth in a customized manner. In other examples, the retention portion 314 may be configured to fit a plurality of patients (and not customized for a particular patient). For example, various installation unit sizes can be made, to fit a large portion of the public, without requiring a customized retention portion 314 for each patient.

The first connection portions 304 are configured to detachably couple to a bracket and/or an orthodontic appliance, such as orthodontic appliance 350, to hold and retain the appliance 350 in place relative to the patient's jaw during installation of the appliance 350. The first connection portions 304 may comprise one or more hooks, tabs, fingers or the like extending from one or more of the retention portions 314. In some embodiments, the first connection portions 304 are configured to receive one or more temporary connection mechanisms (such as a ligature or wire tie) to secure the appliance 350 (or a portion of the appliance 350) thereto. In some embodiments, the first connection portions 304 comprise one or more grooves or recesses in the body of the installation unit 300 that are configured to releasably receive all or a portion of a bracket and/or all or a portion of the appliance 350 (such as all or a portion of an arm, all or a portion of an attachment portion, etc.). For example, the installation unit 300 may have one or more grooves specifically shaped to receive all or a portion of the appliance 350 in a snap fit arrangement.

The second connection portions 306 are configured to detachably couple to a platform, such as platform 360, to hold and retain the platform 360 in place relative to the appliance 350 and/or the patient's jaw during installation of the appliance 350 and/or the platform 360. The second connection portions 306 may comprise one or more hooks, tabs, fingers or the like extending from the frame 316. In some embodiments, one, some, or all of the second connection portions 306 may extend from one or more of the retention portions 314. In some embodiments, the second connection portions 306 are configured to receive one or more temporary connection mechanisms (such as a wire tie 318, as shown in FIG. 3D) to secure the platform 360 (or a portion of the platform 360) thereto. In some embodiments, the second connection portions 306 comprise one or more grooves or recesses in the body of the installation unit 300 that are configured to releasably receive all or a portion of the platform 360 (such as all or a portion of an arm, all or a portion of an attachment portion, etc.). For example, the installation unit 300 may have one or more grooves specifically shaped to receive all or a portion of the platform 360 in a snap fit arrangement.

It will be appreciated that any of the installation units of the present technology (such as installation units 200, 300, 400, 700, etc.) may be used with any suitable orthodontic appliance and/or platform and are not limited to use with the specific orthodontic appliances and platforms shown and described herein. For example, the installation units of the present technology can be used with any of the platforms described in U.S. patent application Ser. No. 16/947,860, filed Aug. 20, 2020, and/or with any of the orthodontic appliances described in U.S. Pat. No. 10,383,707, filed Dec. 6, 2016, and U.S. patent application Ser. No. 15/929,443, filed May 2, 2020, each of which is incorporated herein by reference in its entirety.

The installation unit 300 and appliance 350 may be installed in a manner similar to the procedure described for the installation unit 200 and the appliance 250. However, further operations of connecting the platform 360 to the appliance 350 may be performed (for example, before the installation unit 300 is placed in the patient's mouth, for simplifying installation procedures). In addition, further operations of installing the platform 360 with one or more TADs or other anchoring devices may be performed, after the installation unit 300 is fitted onto the patient's teeth and before the installation unit 300 is removed.

FIGS. 4A and 4B are different views of an installation unit 400 configured in accordance with several embodiments of the present technology. As shown in FIGS. 4A and 4B, the installation unit 400 may comprise a shell having an outer surface 401 and an inner surface 403 configured to face the patient's teeth when the installation unit 400 is secured to one or more of the teeth. The shell may define a recess 426 in which the inner surface 403 has a unique topography configured to detachably couple to all or a portion of an orthodontic device, such as an orthodontic appliance, a bracket, a platform, any combination of the foregoing, and others. The shell is configured to hold the orthodontic appliance during installation of the appliance on the patient's teeth and providing one or more coupling elements for temporarily connecting with the orthodontic device during installation. The one or more coupling elements are configured to release the appliance from the shell, after the orthodontic device is installed on the patient.

According to several embodiments, the installation unit 400 comprises a flexible shell configured to fit over and/or around at least a portion of one, some, or all of the patient's teeth. In some embodiments, the shell has an arch or partial arch shape corresponding to a dental impression of the patient's jaw. In some embodiments, the recess 426 has an arch or partial arch shape corresponding to a dental impression of the patient's jaw. In some embodiments, the shell is a monolithic structure. In some embodiments, the shell comprises multiple components.

The installation unit 400 can comprise a first coupling element and a second coupling element, one configured to be releasably secured to one, some, or all of the patient's teeth, and the other configured to be releasably secured to an orthodontic device. The first coupling element may comprise a single continuous element, or may comprise a plurality of discrete and/or spaced apart elements. Likewise, the second coupling element may comprise a single continuous element, or may comprise a plurality of discrete and/or spaced apart elements.

In some embodiments, the first coupling element comprises one or more grooves in a surface of the installation unit 400 that are shaped to detachably receive an orthodontic device, such as (a) all or a portion of an orthodontic appliance, (b) all or a portion of a bracket, or (c) both (a) and (b). The shell may be formed of a material that holds the orthodontic device securely, but can be pulled away from the orthodontic device once the orthodontic device is installed in the patient's mouth. The first coupling element may be a continuous groove or discontinuous grooves in the material of the installation unit 400 with a shape corresponding to a shape of the orthodontic appliance in an OTA configuration. In some embodiments, the first coupling element may be a continuous groove or discontinuous grooves in the material of the installation unit 400 with a shape corresponding to a shape of the orthodontic appliance in an FTA configuration. The first coupling element may be a groove shaped to receive an anchor portion of the appliance, one or more arms extending away from the anchor portion, and/or one or more attachment portions of the arms. The attachment portions may be configured to attach to a corresponding bracket. In some embodiments, the groove has a first region 432 having a first shape for the anchor portion, a second region 434 having a second shape for the arms, and a third region 436 having a third shape for the attachment portions. The first region 432 of the groove may extend along the arch of the shell. The second region 434 may extend away from the first region 432 and along a straight or serpentine path.

Additionally or alternatively, the first coupling element may include a recess 438 for receiving a bracket. The recess 438, for example, may be incorporated into the shape of the third region 436 of the groove configured to receive the attachment portion of the arm. According to several embodiments, the groove may comprise only the first region 432, only the second region 434, only the third region 436, only the first and second regions, only the first and third regions, or only the second and third regions. The first coupling element may comprise one, some, or all of the foregoing options with or without the recess 438. In some embodiments, the first coupling element only includes the recess 438 and/or is only configured to be directly coupled to the bracket(s).

The recess may be configured to receive the bracket alone, or the bracket while coupled to the orthodontic appliance. Likewise, the groove may be configured to receive the orthodontic appliance alone, or the orthodontic appliance already coupled to the bracket, platform, or other orthodontic device. Accordingly, the orthodontic appliance, bracket(s), platform, or other orthodontic device may be coupled to one another prior to securement in the installation unit. Additionally or alternatively, the orthodontic appliance, bracket(s), platform, or other orthodontic device may be coupled to one another while at least one of the components is already secured within the installation unit.

According to some embodiments, the second coupling element comprises one or more indentations 428 in a surface of the installation unit 400 that are shaped to detachably receive at least a portion of the one or more of the patient's teeth (for example, via a snap fit arrangement). The indentations 428 of the second coupling element may have a shape complementary to the topography of all or a portion of the teeth to which the indentations 428 are intended to be attached. For example, the recesses may have a shape configured to substantially conform to all or a portion of the occlusal surface of one or more of the teeth.

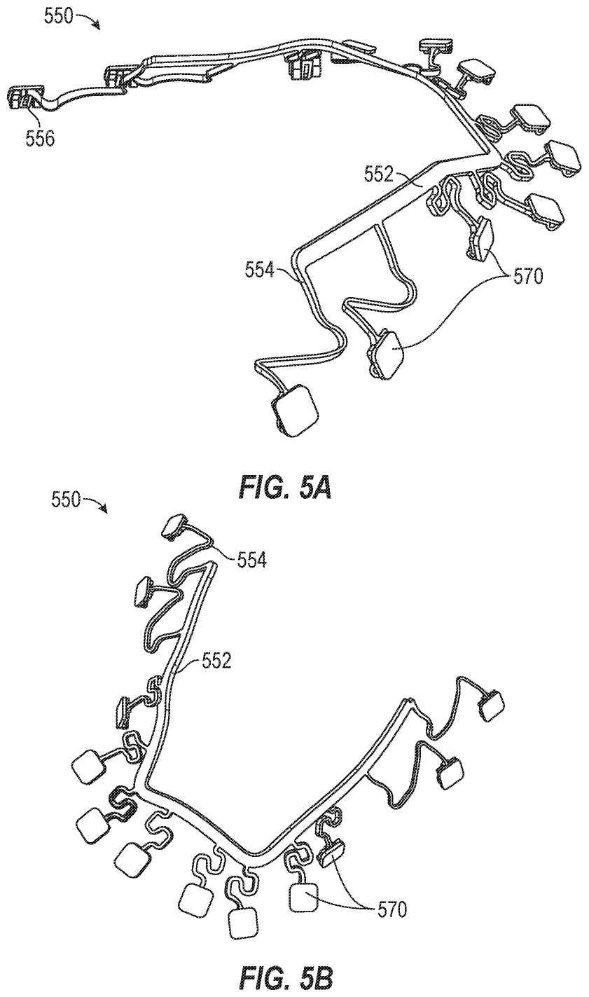

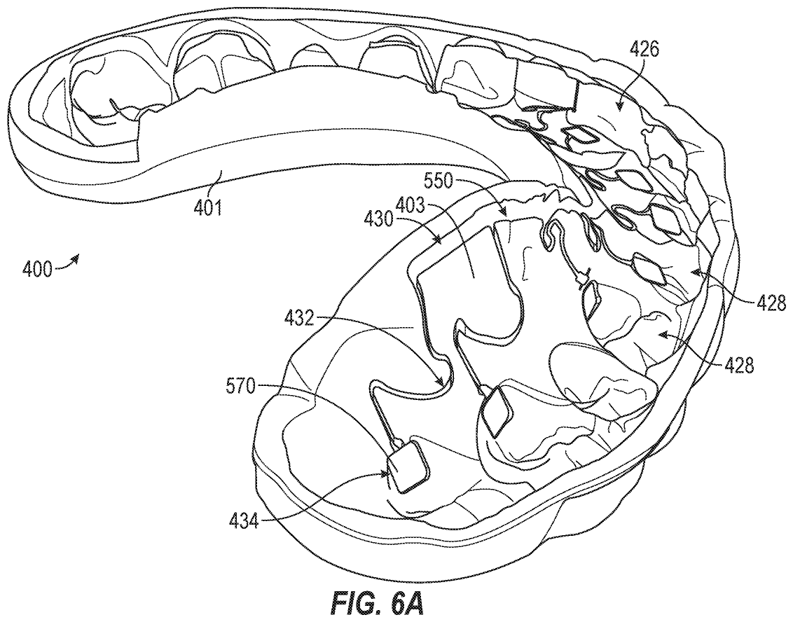

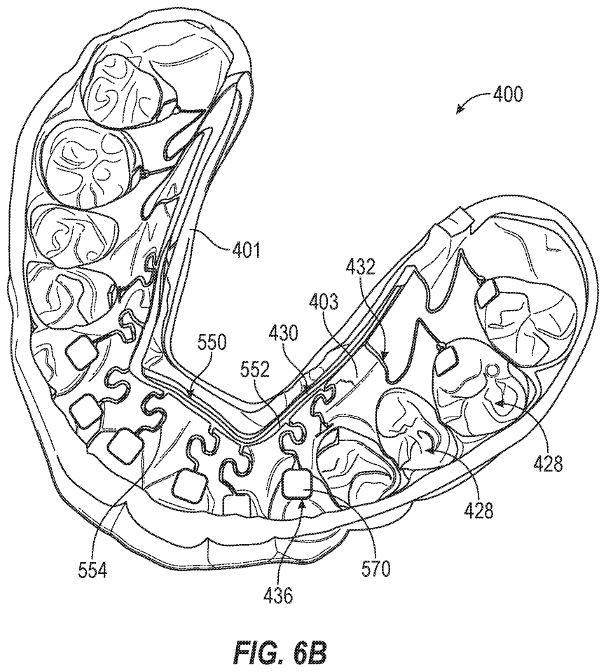

FIGS. 5A and 5B are different views of an orthodontic appliance 550 for use with the installation units of the present technology (such as installation units 200, 300, 400, and 700) shown coupled to a plurality of brackets. As previously discussed, the orthodontic appliance 550 and brackets 570, while coupled together, can be detachably coupled to the installation units of the present technology. FIGS. 6A and 6B, for example, are different views of the installation unit 400 of FIGS. 4A and 4B detachably coupled to the orthodontic assembly shown in FIGS. 5A and 5B.

In several embodiments, including any of the installation unit embodiments discloses herein, the installation unit is configured to retain an orthodontic appliance while the orthodontic appliance is in an OTA. As such, when the installation unit is removed from the patient's mouth after the orthodontic device is secured to the patient's teeth, the orthodontic appliance immediately applies a repositioning force to the teeth.

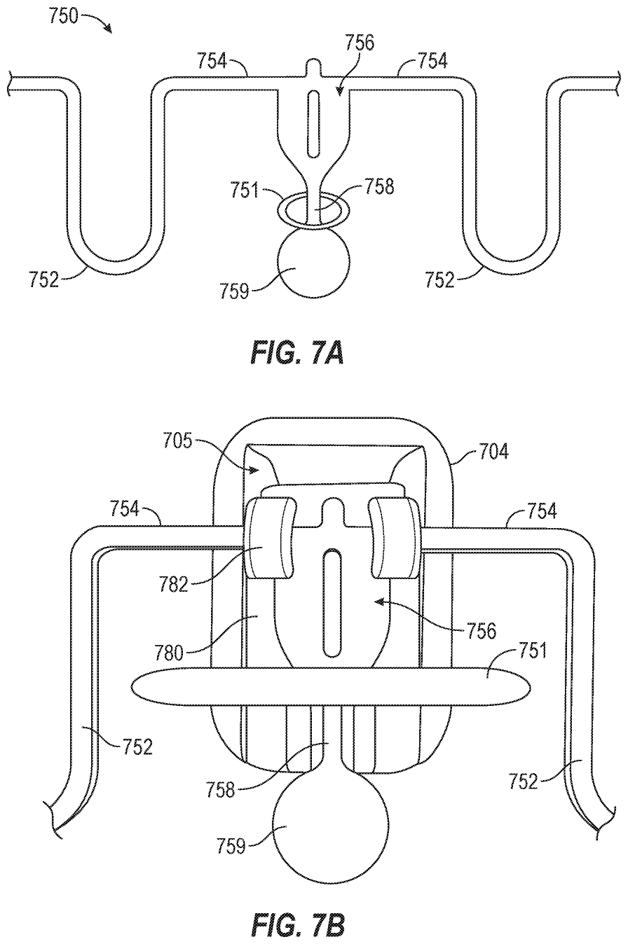

FIG. 7A depicts a portion of an orthodontic appliance 750 for use with the installation units of the present technology. As shown in FIG. 7A, the orthodontic appliance 750 may comprise a plurality of attachment portions 756 connected by a plurality of springs 752. The springs 752, for instance, may be configured to be positioned at an interdental space and apply a biasing force to one or more of the teeth connected to the attachment portions 756. The appliance 750 may optionally include extensions 758 and 759 to facilitate securement to an installation unit, as discussed below.

FIG. 7B shows a connection portion 704 of an installation unit configured in accordance with several embodiments of the present technology. As shown in FIG. 7B, the connection portion 704 may be configured to receive an attachment portion 756 and/or a bracket 780. In some embodiments, the connection portion 704 comprises a recess 705 configured to receive the attachment portion 756 and/or bracket 780. The connection portion 704, for example, may receive the attachment portion 756 and/or bracket 782 in a snap fit arrangement. In some embodiments, a coupling member, such as a wire tie or ligature, may be secured around the connection portion 704 and the attachment portion 756 and/or one or both extensions 758, 759 to secure the appliance 750 to the connection portion 704. The connection portion 704 shown in FIG. 7B may be used, for example, with the body portion of FIGS. 2A and 2B.

In some embodiments, the installation unit may comprise a shell having an outer surface and an inner surface configured to face the patient's teeth when the installation unit is secured to one or more of the teeth. The shell may have a recess defined by the inner surface and within which the inner surface has a unique topography configured to detachably couple one, some, or all of an orthodontic appliance (such as orthodontic appliance 750), a bracket, a platform, or another orthodontic device. According to several embodiments, the installation unit comprises a flexible shell configured to fit over and/or around at least a portion of one or more teeth. In some embodiments, the shell has an arch or partial arch shape corresponding to a dental impression of the patient's jaw.

In several of the foregoing embodiments, the installation unit can comprise a first coupling element and a second coupling element. In some embodiments, the first coupling element comprises one or more indentations in a surface of the installation unit that are shaped to detachably receive (a) all or a portion of an orthodontic appliance, (b) all or a portion of a bracket, or (c) both (for example, via a snap fit arrangement). The first coupling element may be a continuous groove or discontinuous grooves in the material of the installation unit with a shape corresponding to a shape of the orthodontic appliance in an OTA configuration. In some embodiments, the first coupling element may be a continuous groove or discontinuous grooves in the material of the installation unit with a shape corresponding to a shape of the orthodontic appliance in an FTA configuration. The first coupling element may be a groove shaped to receive an appliance comprising a plurality of attachment portions 756 coupled by one or more springs 752. In some embodiments, the first coupling element includes a recess for receiving a bracket, which may be isolated from the orthodontic appliance or coupled to the appliance when received by the recess. The orthodontic appliance, bracket(s), and platform may be coupled to one another prior to securement in the installation unit. Additionally or alternatively, the orthodontic appliance, bracket(s), and platform may be coupled to one another while at least one of the components is already secured within the installation unit.

In several embodiments, including any of the installation unit embodiments discloses herein, the installation unit is configured to retain an orthodontic appliance while the orthodontic appliance is in an OTA. As such, when the installation unit is removed from the patient's mouth after the orthodontic device is secured to the patient's teeth, the orthodontic appliance immediately applies a repositioning force to the teeth.

Accordingly, the installation units described herein allow a doctor, clinician or technician to install an appliance, or a combination of an appliance and brackets, or a combination of an appliance and a platform, or a combination of an appliance, brackets, and a platform in one procedure. In addition, some of the installation connections (e.g., as between the appliance and the brackets or between the appliance and the platform) may be carried out prior to inserting the installation unit into the patient's mouth, to further simplify the installation procedure.

### CONCLUSION

Although many of the embodiments are described above with respect to systems, devices, and methods for treating impacted teeth, the technology is applicable to other applications and/or other approaches, such as general orthodontics. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-7.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. An installation unit for installing an orthodontic treatment device in a patient's mouth, the installation unit comprising:
a body portion having a shape that corresponds to a plurality of the patient's teeth; and
a plurality of connection portions configured to be releasably secured to an orthodontic appliance, wherein the orthodontic appliance is configured to be secured to two or more of the patient's teeth and apply a force to the two or more of the patient's teeth to reposition the two or more teeth,
wherein the installation unit is configured to temporarily retain the orthodontic appliance in a position relative to the installation unit such that, when the installation unit is placed on the patient's teeth, the orthodontic appliance is automatically aligned with the patient's teeth in a desired position for connecting to the teeth.

2. The installation unit of claim 1, wherein the connection portions are disposed along a lingual-facing surface of the body portion.

3. The installation unit of claim 1, wherein each connection portion extends away from the body portion.

4. The installation unit of claim 1, wherein at least some of the connection portions are configured to be releasably secured to the orthodontic appliance via at least one of a snap fit arrangement, a friction fit arrangement, or a separate securing element.

5. The installation unit of claim 1, wherein the body portion has an arch shape corresponding to a dental impression of the patient's jaw.

6. The installation unit of claim 1, wherein each of the connection portions comprises a recessed portion configured to receive a portion of the orthodontic appliance and/or at least one orthodontic bracket.

7. The installation unit of claim 1, wherein each connection portion corresponds to an individual one of the patient's teeth.

8. An installation unit for installing an orthodontic treatment device in a patient's mouth, the installation unit comprising:
a device configured to be temporarily secured to one or more of the patient's teeth, the device comprising a first coupling region and a second coupling region, wherein:
the first coupling region comprises one or more indentations in a surface of the device that are shaped to detachably receive (a) all or a portion of an orthodontic appliance, (b) all or a portion of a bracket, or (c) both, wherein the orthodontic appliance is configured to be secured to two or more of the patient's teeth and apply a force to the two or more of the patient's teeth to reposition the two or more teeth,
the second coupling region comprises one or more recesses in a surface of the device that are shaped to detachably receive at least a portion of the one or more of the patient's teeth,
wherein the installation unit is configured to temporarily retain the orthodontic appliance in a position relative to the installation unit such that, when the installation unit is placed on the patient's teeth, the orthodontic appliance is automatically aligned with the patient's teeth in a desired position for connecting to the teeth.

9. The installation unit of claim 8, wherein the device comprises a flexible cover configured to fit over the one or more teeth.

10. The installation unit of claim 8, wherein the device comprises an outer surface and an inner surface configured to be in apposition with at least a portion of the one or more teeth when the installation unit is secured to the one or more teeth, and wherein the indentations and the recesses are in the inner surface.

11. The installation unit of claim 8, wherein at least one of the indentations or the recesses are configured to detachably receive the orthodontic appliance or the one or more teeth, respectively, via a snap fit arrangement.

12. The installation unit of claim 8, wherein the device further comprises one or more third coupling regions configured to detachably receive all or a portion of a platform.

13. An installation unit for installing an orthodontic treatment device in a patient's mouth, the installation unit comprising:
a shell having a shape that corresponds to one or more teeth in one of the patient's jaws, wherein the shell is configured to hold an orthodontic device during installation of the device on the patient's teeth, and wherein the shell has an outer surface, an inner surface, and a recess defined by the inner surface, wherein the inner surface includes:
a groove configured to receive at least a portion of the orthodontic device, wherein the orthodontic device comprises one or more of an orthodontic appliance, a bracket, and a platform,
an indentation shaped to detachably receive at least a portion of one or more of the patient's teeth,
wherein the installation unit is configured to temporarily retain the orthodontic device in a position relative to the installation unit such that, when the installation unit is placed on the patient's teeth, the orthodontic device is automatically aligned with the patient's teeth in a desired position for connecting to the teeth.

14. The installation unit of claim 13, wherein the orthodontic appliance is configured to be secured to two or more of the patient's teeth and apply a force to the two or more of the patient's teeth to reposition the two or more teeth.

15. The installation unit of claim 13, wherein the groove is configured to detachably couple directly to the orthodontic appliance.

16. The installation unit of claim 13, wherein the groove is configured to detachably couple to at least a portion of one or more brackets while the one or more brackets are coupled to the orthodontic appliance.

17. The installation unit of claim 13, wherein the groove is configured to detachably couple to at least a portion of one or more brackets and all or a portion of the orthodontic appliance while the one or more brackets are coupled to the orthodontic appliance.

18. The installation unit of claim 13, wherein the groove is configured to detachably couple to at least a portion of one or more brackets and all or a portion of the orthodontic appliance while the one or more brackets are coupled to the orthodontic appliance, and while the orthodontic appliance is coupled to the platform.

19. The installation unit of claim 13, wherein the inner surface is configured to be in apposition with at least a portion of the one or more teeth when the installation unit is secured to the one or more teeth.

20. The installation unit of claim 13, wherein at least one of the groove or the indentation is configured to detachably receive the orthodontic device or the one or more teeth, respectively, via a snap fit arrangement.
